(19) United States
(12) Patent Application Publication
(10) Pub. No.: US 2026/0178030 A1
(43) Pub. Date: Jun. 25, 2026

(54) WIRELESS COMMUNICATION DEVICE TO CONTROL SUPPORT FUNCTIONS OF A MACHINE

(71) Applicant: Caterpillar Paving Products Inc., Brooklyn Park, MN (US)

(72) Inventors: Nathaniel DOY, Maple Grove, MN (US); Eric S. ENGELMANN, Delano, MN (US); John Lee MARSOLEK, Watertown, MN (US); Nathan Louis MASHEK, St. Michael, MN (US)

(73) Assignee: Caterpillar Paving Products Inc., Brooklyn Park, MN (US)

(21) Appl. No.: 18/999,151

(22) Filed: Dec. 23, 2024

(51) Int. Cl. G05D 1/226; G05D 105/05; G08C 17/02

(52) U.S. Cl. CPC G05D 1/226; G08C 17/02; G05D 2105/05

(57) ABSTRACT

A wireless communication device includes a communication component configured to wirelessly communicate with a machine, one or more input components, and one or more processors. The one or more processors determine that the wireless communication device is paired to the machine and identify, based on determining that the wireless communication device is paired to the machine, a first layout configuration associated with the machine. The first layout configuration identifies a correspondence between a particular input component, of the one or more input components, and a particular support function of the machine. The one or more processors cause the first layout configuration to be applied to the one or more input components.

### TECHNICAL FIELD

The present disclosure relates generally to a wireless communication device and, for example, to a wireless communication device to control support functions of a machine.

### BACKGROUND

A team of operators of a machine can control primary functions and support functions of the machine to cause the machine to perform a work operation at a work site. For example, when the machine is a paving machine, a first operator can be positioned at an operator station on the machine and may control primary functions of the machine (e.g., via the operator station), such as functions related to driving the machine on a path that is to be paved and causing other components of the machine to lay an asphalt mat as the machine travels the path. A second operator can be deployed on the ground to monitor the laid asphalt mat and can accompany the machine as the machine travels along the path. At certain times, the second operator controls support functions of the machine (e.g., via a control panel on a side of the machine), such as functions related to fine tuning a thickness, size, uniformity, crown profile, and cross slope of the asphalt mat. Due to constantly changing environmental conditions at the work site—such as weather, topography, and other factors—the second operator is often not near the control panel when the support functions of the machine need to be controlled (e.g., to fine tune a support function parameter). This can impact the machine's performance of a work operation (e.g., a paving operation) and thus reduce a quality of the result (e.g., an asphalt mat) of the work operation performed by the machine.

U.S. Pat. No. 8,428,791 (“the '791 patent”) discloses a control system for a remote-controlled working machine provided with caterpillar tracks for the travel thereof, the said control system including a remote control intended to be carried by an operator situated beside the machine, the remote control being connected by means of Bluetooth, wirelessly or by means of a cable to an electronic unit in the machine, and having at least two control sticks or joysticks and a number of buttons and/or knobs for operating the different travel and working functions of the machine. However, the control system the '791 patent is intended for demolition robots that are remote-controlled working machines intended for different demolition operations.

The wireless communication device of the present disclosure solves one or more of the problems set forth above and/or other problems in the art.

### SUMMARY

In some implementations, a wireless communication device includes a communication component configured to wirelessly communicate with a machine; one or more input components; and one or more processors configured to: determine that the wireless communication device is paired to the machine; identify, based on determining that the wireless communication device is paired to the machine, a first layout configuration associated with the machine, wherein the first layout configuration identifies a correspondence between a particular input component, of the one or more input components, and a particular support function of the machine; and cause the first layout configuration to be applied to the one or more input components.

In some implementations, a system to facilitate wireless control of support functions of a machine includes a wireless communication device configured to: determine that the wireless communication device is paired to a machine; identify, based on determining that the wireless communication device is paired to the machine, a first layout configuration associated with the machine, wherein the first layout configuration identifies a correspondence between a particular input component, of one or more input components of the wireless communication device, and a particular support function of the machine; and cause the first layout configuration to be applied to the one or more input components of the wireless communication device.

In some implementations, a method includes determining, by a wireless communication device, that the wireless communication device is paired to a machine; identifying, by the wireless communication device, and based on determining that the wireless communication device is paired to the machine, a first layout configuration associated with the machine, wherein the first layout configuration is associated with at least a particular support function of the machine; and causing the first layout configuration to be applied to one or more input components of the wireless communication device.

### BRIEF DESCRIPTION OF THE DRAWINGS

FIGS. 1A-1B are diagrams of an example wireless communication device.

FIG. 2 is a side view of an example machine.

FIG. 3 is a diagram of an example system described herein.

FIGS. 4A-4B are diagrams of example measurement scenarios described herein.

FIG. 5 is a diagram of example components of a device associated with a wireless communication device to control support functions of a machine.

### DETAILED DESCRIPTION

This disclosure relates to a wireless communication device, such as to control support functions of a machine. Support functions are secondary functions that enhance a performance of the machine, but are not directly involved in primary functions of the machine, such as energy control functions (e.g., startup of a power source of the machine, acceleration of the machine, braking of the machine) or primary operations of implements. Put another way, support functions include functions that enhance or optimize primary functions, such as by making primary functions more efficient, more effective, or more accurate. For example, support functions include fine-tuning positioning, configuration, and/or operation of components of a machine or an implement to improve a performance of the machine. In many cases, support functions are monitored by a deployed operator of the machine (e.g., someone who is on the ground, or is otherwise not within an operator station of the machine) and can examine a result of a work operation performed by the machine.

Thus, the wireless communication device is applicable to any machine that performs work operations that require performance of support functions, such as a vehicle, a compactor machine, a paving machine, a cold planer, a road reclaimer, a grading machine, a backhoe loader, a wheel loader, a harvester, an excavator, a motor grader, a skid steer loader, a tractor, a dozer, or other above-ground equipment, underground equipment, aerial equipment, or marine equipment.

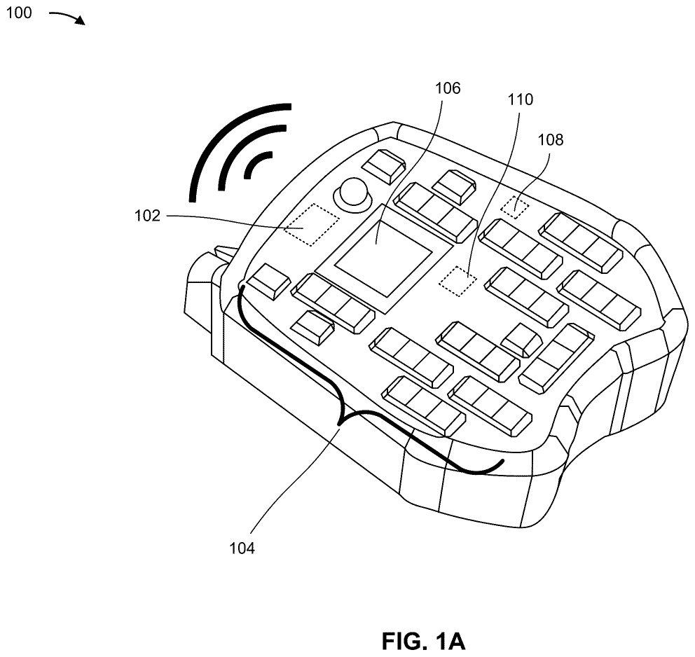

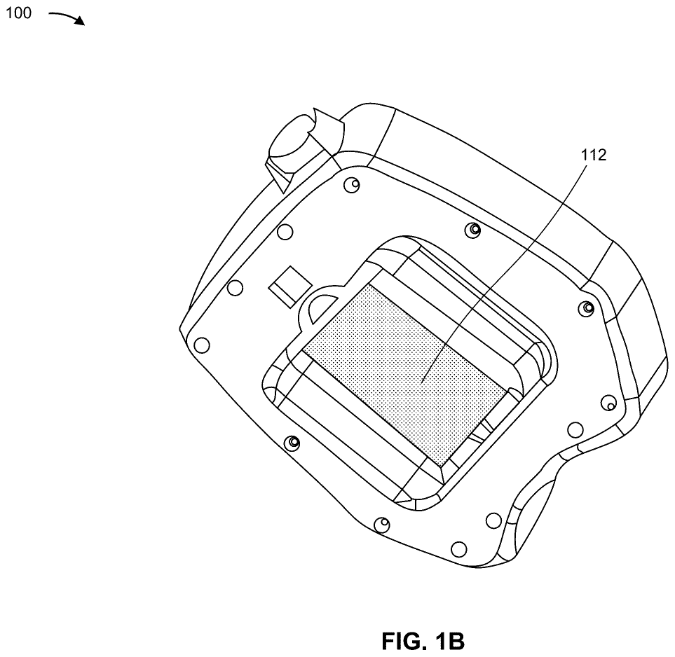

FIGS. 1A-1B are diagrams of an example wireless communication device 100. The wireless communication device 100 may be configured to control (e.g., wirelessly control) support functions of a machine (e.g., the machine 200 described herein), such as when the wireless communication device 100 is paired to the machine. FIG. 1A shows an angled front view of the wireless communication device 100, and FIG. 1B shows an angled rear view of the wireless communication device 100.

As shown in FIGS. 1A-1B, the wireless communication device 100 may include a communication component 102, one or more input components 104, one or more output components 106, a measurement component 108, one or more processors 110, and/or a battery 112.

The communication component 102 may be configured to wirelessly communicate with a machine, such as the machine 200 described herein. The communication component 102 may include a transceiver, a separate transmitter and receiver, and/or an antenna, along with other examples. The communication component 102 may include, for example, at least one of a radio frequency (RF) component, a Bluetooth component, a Zigbee component, a WiFi component, a Z-wave component, a Matter component, or a cellular component. The communication component 102 may be configured to communicate with the machine via a network that includes one or more wired and/or wireless networks.

The one or more input components 104 may be configured to allow an operator of the wireless communication device 100 to input control information (e.g., to control support functions of the machine), such as by the operator interacting with the plurality of input components 104. The one or more input components 104 may include a button, a dial, a knob, a slider, a joystick, a camera, an optical scanner (e.g., a barcode scanner or a quick response (QR) code scanner), a gesture sensor, a microphone, and/or a touch-sensitive component (e.g., a touchscreen, a touchpad, or a capacitive sensor), along with other examples of input components. The one or more input components 104 (e.g., when engaged by the operator of the wireless communication device 100) may be configured to generate one or more commands (e.g., to control support functions of the machine) and/or other information that can be wirelessly communicated by the wireless communication device 100 (e.g., via the communication component 102).

Respective functions of the one or more input components 104 may be determined based on a layout configuration that is applied to the one or more input components 104, as further described herein. For example, a layout configuration may identify a correspondence between a particular input component 104, of the one or more input components 104, and a particular function (e.g., a particular support function of a machine). Accordingly, when an operator of the wireless communication device 100 interacts with the particular input component 104, the wireless communication device 100 may generate one or more commands and/or other information that can be wirelessly communicated by the wireless communication device 100 to cause an update to one or more parameters associated with the particular function. Different layout configurations may be applied to the one or more input components 104 at different times. Thus, an input component 104 may have a first correspondence to a first function when a first layout configuration is applied and may have a second correspondence to a second function (e.g., that is different than the first function) when a second layout configuration is applied.

The one or more output components 106 may be configured to present information, such as to the operator of the wireless communication device 100. The one or more output components 106 may include a light indicator (e.g., a light emitting diode (LED) indicator), an audio component (e.g., a speaker or a buzzer), a display screen, and/or a haptic feedback component, along with other examples of output components. The one or more output components 106 may be configured to present notifications, alerts, and/or other information (e.g., associated with controlling support functions of the machine) that is communicated to the wireless communication device 100 (e.g., via the communication component 102).

The measurement component 108 may be configured to measure a result of a work operation performed by the machine. For example, when the machine is a paving machine and a result of a work operation of the machine is an asphalt mat, the measurement component 108 may be configured to measure one or more characteristics of the asphalt mat, such as a thickness, a size, a uniformity, a crown profile, and/or a cross slope of the asphalt mat. As another example, when the machine is a milling machine and a result of a work operation of the machine is a milled asphalt mat, the measurement component 108 may be configured to measure one or more characteristics of the milled asphalt mat, such as a surface texture, a milling depth, and/or a milling width of the milled asphalt mat. The measurement component may include a ruler (e.g., a digital ruler), a sonar sensor, an ultrasonic sensor, a camera, an inertial measurement unit (IMU) (e.g., that includes an accelerometer and/or a gyroscope), a time-of-flight (ToF) sensor, a laser sensor, a light detection and ranging (LIDAR) sensor, a radio detection and ranging (RADAR) sensor, and/or another type of sensor to perceive an environment of the machine 200.

The one or more processors 110 may be configured to control the wireless communication device 100. For example, the one or more processors 110 may be configured to generate one or more commands to control the communication component 102, the one or more input components 104, the one or more output components 106, the measurement component 108, and/or the battery 112, as further described herein.

The battery 112 may be configured to provide electric power to the wireless communication device 100 (e.g., to power the wireless communication device 100 when the wireless communication device 100 is operating). Additionally, the battery 112 may be configured to receive electric power from a charging component of a machine (e.g., to charge the battery 112), as further described herein.

As indicated above, FIGS. 1A-1B are provided as an example. Other examples may differ from what is described with regard to FIGS. 1A-1B.

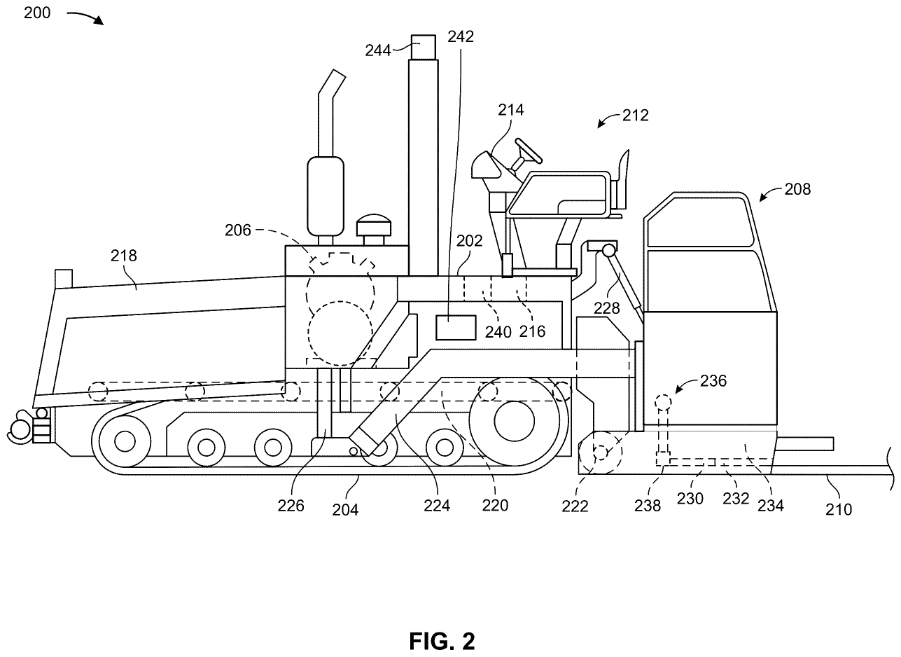

FIG. 2 is a side view of an example machine 200. FIG. 2 shows an example where the machine 200 is a paving machine. However, as described above, the machine 200 may be any machine that utilizes support functions.

The machine 200 includes a frame 202 with a set of ground-engaging elements 204 such as tracks or wheels coupled with the frame 202. The ground-engaging elements 204 may be driven by a powertrain system 206. Additionally, or alternatively, the powertrain system 206 may include a power source (e.g., an internal combustion engine, an electric motor, or a hybrid system) to drive or power another component or system of the machine 200, such as one or more pumps (e.g., of a hydraulic power system of the machine 200) and/or other components described herein. A screed 208 can be positioned at the rear end of the machine 200 to spread and compact paving material into an asphalt mat 210 having a desired thickness, size, uniformity, crown profile, and cross slope. The machine 200 also includes an operator station 212 having a seat and a console, which includes a control panel 214 for directing operations of the machine 200. A controller 216 is provided for electrically controlling various aspects of the machine 200. For example, the controller 216 can send and receive signals from various components of the machine 200 during the operation of the machine 200.

The machine 200 further includes a hopper 218 for storing a paving material, and a conveyor system including one or more conveyors 220 configured to move paving material from the hopper 218 to the screed 208 at the rear of the machine 200. One or more augers 222 are arranged near the forward end of the screed 208 to receive the paving material supplied by the conveyor 220 and spread the material evenly beneath the screed 208. The screed 208 can be pivotally coupled behind the machine 200 by one or more tow arms 224 that extend between the frame 202 of the paving machine and the screed 208. Alternatively, the screed 208 can be pivotally coupled behind the machine 200 by a pair of tow arms 224 that extend between a tow point on the frame 202 of the machine 200 and the screed 208.

The tow arms 224 can also have the tow point raised and lowered on the machine 200 using a positioning cylinder 226 which, when moved up and down, moves the tow point of the tow arms 224 and changes an angle of attack of the screed 208. Also, as part of a paving process, one or more cylinders 228 on the screed 208 can raise or lower portions of the screed 208. For example, to change a height or paving angle of a main screed plate 230, the machine 200 may use one or more extender screed plates 232. The screed 208 can include a screed frame 234 with the main screed plate 230 coupled to the screed frame 234. The main screed plate 230 is configured to float on the paving material of the asphalt mat 210 laid upon a prepared paving bed and to “smooth” or level and compact the paving material on the base surface (e.g., a roadway or roadbed). The screed 208 can further include the one or more extender screed plates 232 that extend beyond the main screed plate 230 to extend the paving width of the screed 208.

The screed 208 can include a tamper bar assembly 236 positioned forward of the main screed plate 230 and extending transversely to the direction of travel of the machine 200. The tamper bar assembly 236 may include a tamper bar 238. The tamper bar assembly 236 can be coupled to the screed frame 234 of screed 208 and configured such that the tamper bar 238 is reciprocated in an upward and downward direction substantially perpendicular to the asphalt mat 210 and substantially perpendicular to the direction of travel of the machine 200. The tamper bar assembly 236 pre-compacts the paving material as the machine 200 moves forward, and the screed 208 smooths the paving material to remove air pockets and other voids to create a relatively flat, paved surface.

The machine 200 further includes a communication component 240 that is configured to wirelessly communicate with one or more devices, such as the wireless communication device 100 described herein. The communication component 240 may include a transceiver, a separate transmitter and receiver, and/or an antenna, along with other examples. The communication component 240 may include, for example, at least one of an RF component, a Bluetooth component, a Zigbee component, a WiFi component, or a cellular component. The communication component 240 may be configured to communicate with the one or more devices via a network that includes one or more wired and/or wireless networks. The communication component 240 may be configured to wirelessly communicate with the wireless communication device 100 to enable pairing of the wireless communication device 100 to the machine 200 (and to therefore enable the wireless communication device 100 to control support functions of the machine 200, as further described herein).

The machine 200 may further include a charging component 242 that is configured to charge a battery, such as the battery 112 of the wireless communication device 100 (e.g., as part of a battery charging operation). The charging component 242 may include a dock, cradle, or other structural component to receive and hold the battery to facilitate charging of the battery. Accordingly, when the battery is in a charging position with respect to the charging component, the charging component 242 may cause the battery to be charged (e.g., as part of a battery charging operation) via direct current (DC), alternating current (AC), or inductive charging.

The machine 200 may further include one or more perception sensors 244 that are configured to capture perception data that can be used (e.g., by the controller 216) to determine a position (e.g., that indicates a distance and an azimuth angle, along with other examples) of a target (e.g., the wireless communication device 100), such as relative to the machine 200. The one or more perception sensors 244 may include a sonar sensor, a camera, a LIDAR sensor, a RADAR sensor, and/or another type of sensor to perceive an environment of the machine 200.

As indicated above, FIG. 2 is provided as an example. Other examples may differ from what is described with regard to FIG. 2.

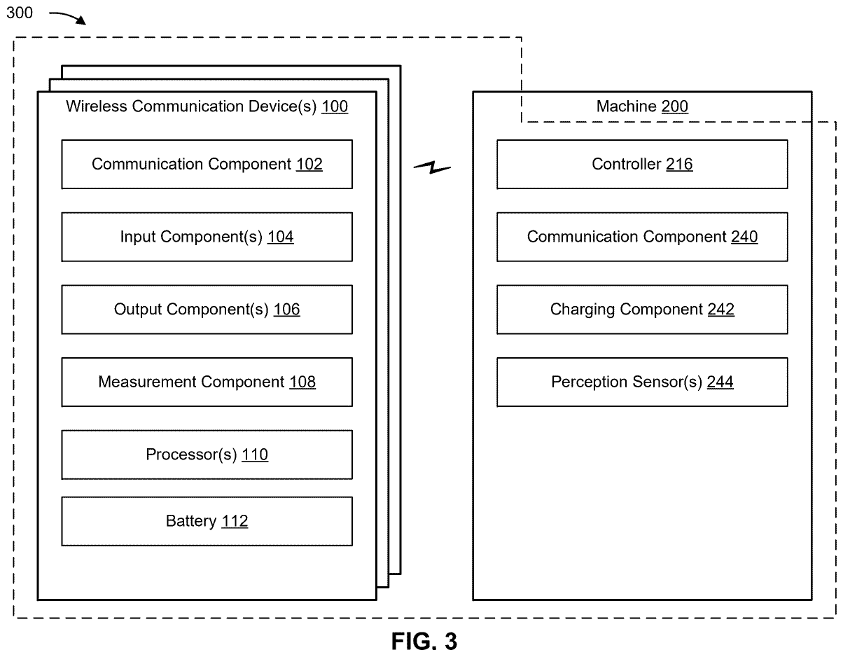

FIG. 3 is a diagram of an example system 300 described herein. The system 300 may facilitate wireless control of a machine (e.g., of support functions of the machine), such as the machine 200. As shown in FIG. 3, the system 300 may include one or more wireless communication devices 100, each of which may include a communication component 102, one or more input components 104, one or more output components 106, a measurement component 108, one or more processors 110, and/or a battery 112, as described herein in relation to FIGS. 1A-1B. As additionally shown in FIG. 3, the system 300 may further include a controller 216, a communication component 240, a charging component 242, and/or one or more perception sensors 244 that are configured to be included in the machine 200, as described herein in relation to FIG. 2.

Each wireless communication device 100, of the one or more wireless communication devices 100, may pair (or may be paired) with the machine 200. To do so, a wireless communication device 100 (e.g., using the one or more processors 110 of the wireless communication device 100) may obtain (e.g., from at least one input component 104, of the one or more input components 104, or the communication component 102 of the wireless communication device 100) information that identifies the machine 200. For example, an input component 104 may scan a barcode, a QR code, or an alphanumeric string (e.g., that is positioned at a particular location on the machine 200) to capture the information that identifies the machine 200, and the input component 104 may send the information that identifies the machine to the one or more processors 110. As another example, the communication component 102 may discover and communicate with the communication component 240 of the machine 200 (e.g., as part of a pairing initialization operation) to receive the information that identifies the machine 200, and the communication component 102 may send the information that identifies the machine 200 to the one or more processors 110.

Accordingly, the one or more processors 110 may cause (e.g., based on obtaining the information that identifies the machine 200), the communication component 102 to wirelessly transmit a wireless pairing request to the machine 200 (e.g., to the communication component 240 of the machine 200). For example, the one or more processors 110 may generate the wireless pairing request (e.g., to include at least some of the information that identifies the machine 200 and/or to include information that identifies the wireless communication device 100), and may send the wireless pairing request to the communication component 102 to cause the communication component 102 to wirelessly transmit the pairing request to the machine 200. Accordingly, the one or more processors 110 may obtain (e.g., after transmission of the wireless pairing request), wirelessly via the communication component 102, a pairing confirmation from the machine 200. For example, the machine 200 (e.g., using the controller 216) may generate (e.g., in response to the wireless pairing request) a pairing confirmation and may send the pairing confirmation to the communication component 240 of the machine 200 to cause the communication component 240 to wirelessly transmit the pairing confirmation to the wireless communication device 100. The communication component 102 of the wireless communication device 100 may thereby receive the pairing confirmation and may send the pairing confirmation to the one or more processors 110. In this way, the wireless communication device 100 may pair with the machine 200.

Accordingly, a wireless communication device 100, of the one or more wireless communication devices 100, may determine that the wireless communication device 100 is paired to the machine 200. The wireless communication device 100 then may identify (e.g., using the one or more processors 110), a layout configuration associated with the machine 200. The layout configuration may identify a correspondence between at least some of the one or more input components 104 and support functions of the machine 200. For example, when the machine 200 is a paving machine, as shown in FIG. 2, the layout configuration may identify respective correspondences between sets of input components 104 and support functions associated with the asphalt mat 210 having a desired thickness, size, uniformity, crown profile, and/or cross slope. Accordingly, the wireless communication device 100 (e.g., using the one or more processors 110) may cause the layout configuration to be applied to the one or more input components 104 of the wireless communication device 100.

Thus, to control support functions of the machine 200, the wireless communication device 100 (e.g., using the one or more processors 110) may identify (e.g., based on causing the layout configuration to be applied to the one or more input components 104) that a particular input component 104 is engaged (e.g., based on an operator of the wireless communication device 100 interacting with the particular input component 104). The wireless communication device 100 (e.g., using the communication component 102), based on identifying that the particular input component 104 is engaged, may wirelessly transmit control information associated with a particular support function of the machine 200 that corresponds to the particular input component 104 (e.g., as indicated by the layout configuration) to the machine 200. Accordingly, the controller 216 of the machine 200 may obtain (e.g., wirelessly via the communication component 240 of the machine 200) the control information, and may thereby control one or more components of the machine 200 (e.g., that are associated with the particular support function) in accordance with the control information.

The layout configuration may be associated with a mode of the machine 200. For example, the machine 200 may have a work mode (e.g., for performing a work operation), a diagnostic mode (e.g., for assessing a health and functionality of machine 200 and/or components of the machine 200), a maintenance mode (e.g., for cleaning, updating, repairing, and/or replacing components of the machine 200), or another type of mode. Accordingly, the wireless communication device 100 may identify and apply a particular layout configuration that is associated with a particular mode of the machine 200 when the machine 200 is operating in the particular mode.

For example, a first layout configuration may be associated with a first mode of the machine 200 and a second layout configuration may be associated with a second mode of the machine 200. The first layout configuration may identify a correspondence between a particular input component 104 of the wireless communication device 100 and a particular support function of the machine 200, and the second layout configuration may identify a correspondence between the particular input component 104 and another particular support function of the machine 200 (e.g., that is different than the particular support function of the machine 200). The machine 200 may operate in the first mode and therefore the wireless communication device 100 (e.g., using the one or more processors 110) may identify and cause the first layout configuration to be applied to the one or more input components 104 of the wireless communication device 100.

Thereafter, the controller 216 of the machine 200 may determine that the machine 200 transitioned from operating in the first mode to operating in the second mode (e.g., based on monitoring operation parameters of the machine 200), and may thereby cause the communication component 240 of the machine 200 to wirelessly transmit mode information associated with the machine 200 to the wireless communication device 100. The mode information may indicate, for example, that a mode of the machine 200 has changed and/or that machine 200 has transitioned to the second mode. Accordingly, the wireless communication device 100 (e.g., using the one or more processors 110) may determine that the machine 200 transitioned from operating in the first mode to operating in the second mode (e.g., based on receiving the mode information). The wireless communication device 100 (e.g., using the one or more processors 110) then may identify the second layout configuration that is associated with the second mode of the machine 200, and may cause the second layout configuration to be applied to the one or more input components 104 of the wireless communication device 100. In this way, the wireless communication device 100 may be updated to enable control of the other particular support function of the machine 200 (e.g., that is associated with the second mode).

In some implementations, the controller 216 of the machine 200 may determine information indicating a position of a wireless communication device 100 with respect to the machine 200 (e.g., based on information obtained from at least one of the communication component 240 or the one or more perception sensors 244 of the machine 200). For example, the one or more perception sensors 244 may capture perception data that indicates a position of the wireless communication device 100 to the machine 200 and may send the perception data to the controller 216. Thereafter, the controller 216 may cause the communication component 240 to wirelessly transmit the information indicating the position of the wireless communication device 100 with respect to the machine 200 to the wireless communication device 100. Accordingly, the wireless communication device 100 (e.g., using the one or more processors 110) may obtain, via the communication component 102, the information indicating the position of the wireless communication device 100 with respect to the machine 200 and may thereby selectively cause (e.g., based on the information indicating the position of the wireless communication device 100 with respect to the machine 200) respective enablement or disablement of a set of one or more input components 104 of the wireless communication device 100. That is, the wireless communication device 100 may cause at least one of a first set of one or more input components 104, of the one or more input components 104, to be enabled, or a second set of one or more input components 104, of the one or more input components 104, to be disabled. For example, when the information indicates that the wireless communication device 100 is positioned on a first side of the machine 200, the wireless communication device 100 may cause a first set of one or more input components 104 that are associated with support functions of the first side to be enabled and/or may cause a second set of one or more input components 104 that are associated with support functions of a second side to be disabled.

Additionally, or alternatively, the wireless communication device 100 (e.g., using the one or more processors 110) may cause the one or more output components 106 of the wireless communication device 100 to provide a presentation that indicates at least some of the information indicating the position of the wireless communication device 100 with respect to the machine 200. For example, when the information indicates that the wireless communication device 100 is positioned too far from the machine 200 (e.g., such that communication between the wireless communication device 100 and machine 200 may be inhibited) or too near the machine 200 (e.g., within an operating zone of the machine 200), the wireless communication device 100 may cause the one or more output components 106 to provide a visible, audible, and/or haptic alert or message that indicates that the wireless communication device 100 is not within a preferred range of the machine 200. As another example, when the information indicates that the wireless communication device 100 is positioned on a first side of the machine 200, the wireless communication device 100 may cause the one or more output components 106 to provide a presentation that indicates that the wireless communication device 100 is positioned on the first side, and information associated with a second side of the machine (e.g., that is obtained from the one or more perception sensors 244, such as perception data that includes a video feed associated with the second side of the machine 200).

In some implementations, multiple wireless communication devices 100 may pair with (or may be paired with) the machine 200. Accordingly, each wireless communication device 100 may identify and cause a layout configuration to be applied to the one or more input components 104 of the wireless communication device 100. For example, a first wireless communication device 100 may be associated with (and/or positioned on) a first side of the machine 200, and may therefore identify and cause a first layout configuration to be applied that is associated with support functions of the first side of the machine 200, and a second wireless communication device 100 may be associated with (and/or positioned on) a second side of the machine 200 (e.g., that is different than the first side), and may therefore identify and cause a second layout configuration to be applied that is associated with support functions of the second side of the machine 200. In this way, a first operator may interact with the first wireless communication device 100 to control the support functions of the first side of the machine 200, and a second operator may interact with the second wireless communication device 100 to control the support functions of the second side of the machine 200.

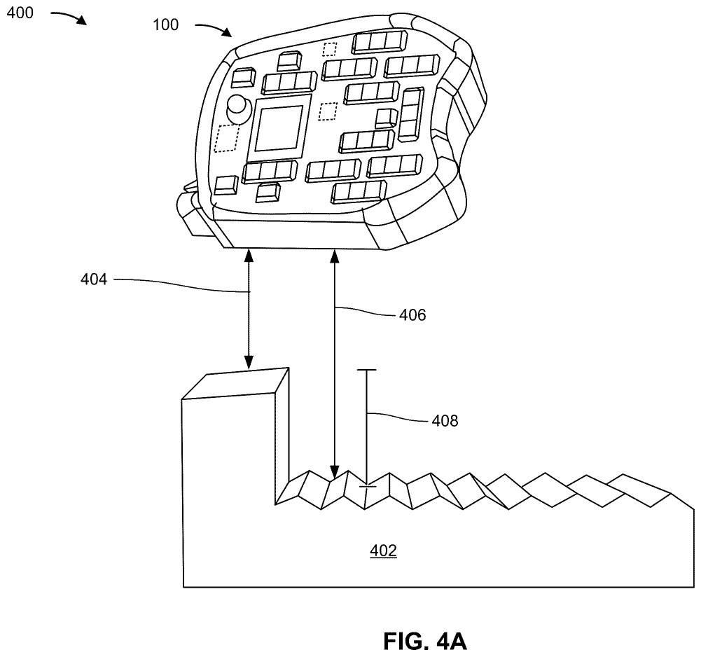

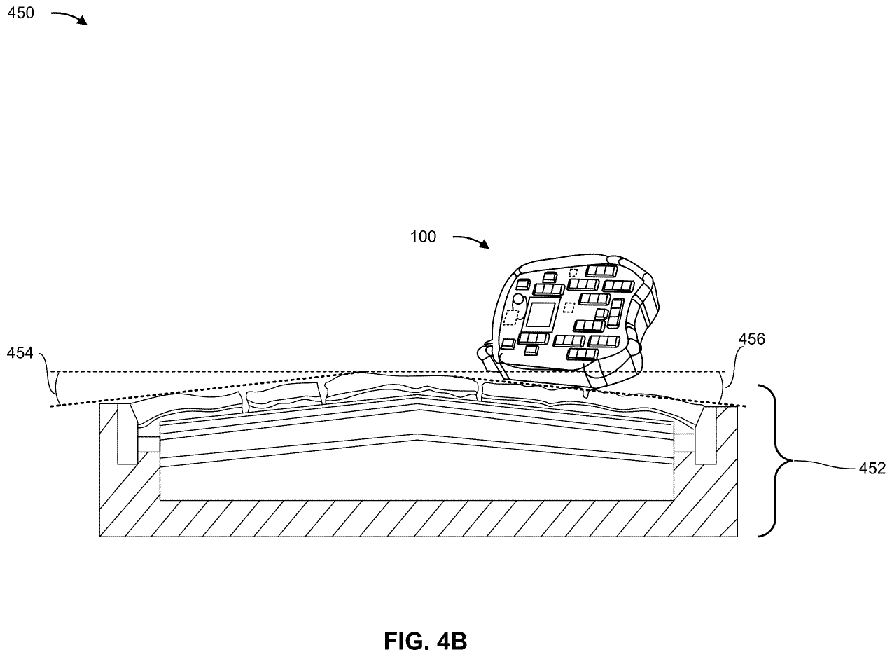

In some implementations, a wireless communication device 100, of the one or more wireless communication devices 100, may be used to measure a result of a work operation performed by the machine 200, such as the asphalt mat 210 spread by the machine 200 when the machine 200 is a paving machine. An operator of the wireless communication device 100 may interact with the one or more input components 104 of the wireless communication device 100 to cause the measurement component 108 to capture measurement information associated with the result of the work operation performed by the machine 200. For example, the operator of the wireless communication device 100 may position the wireless communication device 100 with respect to the result of the work operation (e.g., as further described herein in relation to FIGS. 4A-4B) such that the measurement component 108 is able to capture measurement information associated with the result of the work operation when the operator interacts with the one or more input components 104. Accordingly, the one or more processors 110 of the wireless communication device 100 may obtain the measurement information (e.g., from the measurement component 108). The one or more processors 110 may cause the one or more output components 106 of the wireless communication device 100 to provide a presentation that indicates at least some of the measurement information (e.g., to provide actionable information to the operator of the wireless communication device 100 for controlling at least one support function of the machine 200) and/or may cause the communication component 102 to wirelessly transmit the measurement information to the machine 200 (e.g., to facilitate control of the at least one support function of the machine 200).

The charging component 242 of the machine 200 may charge a battery 112 of a wireless communication device 100. For example, an operator of the wireless communication device 100 may position the wireless communication device 100 such that the battery 112 of the wireless communication device 100 is placed inside a dock, cradle, or other structural component of the charging component 242 that is configured to receive and hold the battery 112 of the wireless communication device 100. The charging component 242 then may identify that the battery 112 of the wireless communication device 100 is in a charging position with respect to the charging component 242 (e.g., to facilitate DC, AC, or inductive charging) and may thereby cause (e.g., based on identifying that the battery 112 is in the charging position) a battery charging operation to be initiated (e.g., to cause the battery 112 to be charged).

As indicated above, FIG. 3 is provided as an example. Other examples may differ from what is described with regard to FIG. 3.

FIGS. 4A-4B are diagrams of example measurement scenarios 400, 450 described herein.

As shown in FIG. 4A, a first example measurement scenario 400 includes the wireless communication device 100 and a milled asphalt mat 402, which may be a result of a work operation performed by the machine 200 (e.g., when the machine 200 is a milling machine). An operator of the wireless communication device 100 may position the wireless communication device 100 with respect to the milled asphalt mat 402, such that the measurement component 108 of the wireless communication device 100 is able to capture a first distance 404 from the wireless communication device 100 to an unmilled portion (or a yet-to-be-milled portion) of the milled asphalt mat 402 and a second distance 406 from the wireless communication device 100 to a milled portion of the milled asphalt mat 402. The measurement component 108 may send the first distance 404 and the second distance 406 as measurement information to the one or more processors 110 of the wireless communication device 100. The one or more processors 110 may thereby determine a milling depth 408 associated with the milled asphalt mat 402 (e.g., based on determining a difference between the first distance 404 and the second distance 406).

As shown in FIG. 4B, a second example measurement scenario 450 includes the wireless communication device 100 and an asphalt mat 452, which may be a result of a work operation performed by the machine 200 (e.g., when the machine 200 is a paving machine). An operator of the wireless communication device 100 may position the wireless communication device 100 at a first location on the asphalt mat 452 (e.g., on a first “side” of the asphalt mat 452), such that the measurement component 108 of the wireless communication device 100 is able to capture a first slope angle 454 of the asphalt mat 452 associated with the first location (e.g., as compared to a horizontal portion of the asphalt mat 452, which may be associated with a peak of the asphalt mat 452), and then may position the wireless communication device 100 at a second location on the asphalt mat 452 (e.g., on a second “side” of the asphalt mat 452), such that the measurement component 108 is able to capture a second slope angle 456 of the asphalt mat 452 associated with the second location (e.g., as compared to the horizontal portion of the asphalt mat 452). The measurement component 108 may send the first slope angle 454 and the second slope angle 456 as measurement information to the one or more processors 110 of the wireless communication device 100. The one or more processors 110 may thereby determine a crown profile and/or a cross slope associated with the asphalt mat 452 (e.g., based on the first slope angle 454 and the second slope angle 456).

As indicated above, FIGS. 4A-4B are provided as an example. Other examples may differ from what is described with regard to FIGS. 4A-4B.

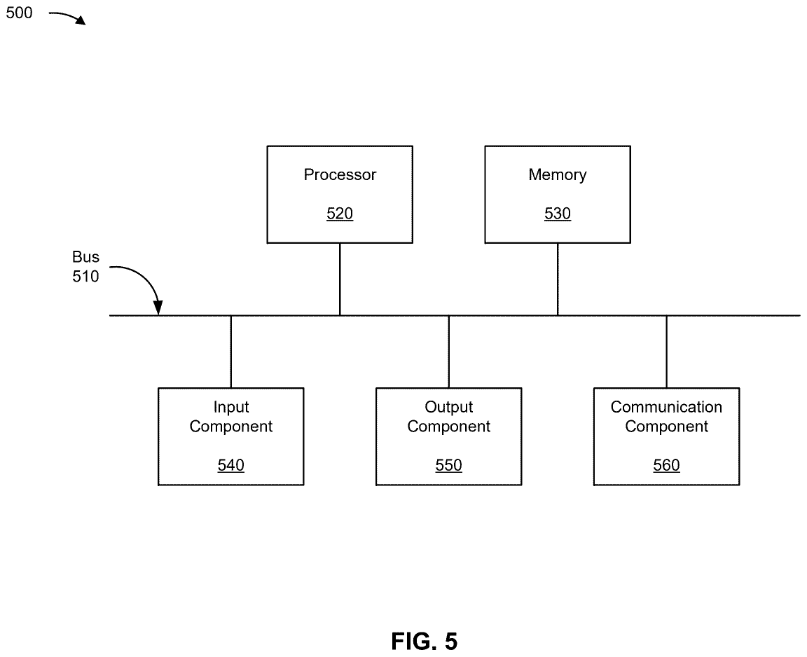

FIG. 5 is a diagram of example components of a device 500 associated with a wireless communication device to control support functions of a machine. The device 500 may correspond to the wireless communication device 100, the machine 200, the system 300, and/or components thereof. In some implementations, the wireless communication device 100, the machine 200, the system 300, and/or the components thereof, may include one or more devices 500 and/or one or more components of the device 500. As shown in FIG. 5, the device 500 may include a bus 510, a processor 520, a memory 530, an input component 540, an output component 550, and/or a communication component 560.

The bus 510 may include one or more components that enable wired and/or wireless communication among the components of the device 500. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 may include a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 may include one or more processors capable of being programmed to perform one or more operations or processes described elsewhere herein.

The memory 530 may include volatile and/or nonvolatile memory. For example, the memory 530 may include random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). The memory 530 may be a non-transitory computer-readable medium. The memory 530 may store information, one or more instructions, and/or software (e.g., one or more software applications) related to the operation of the device 500. In some implementations, the memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530.

The input component 540 may enable the device 500 to receive input, such as user input and/or sensed input. For example, the input component 540 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 550 may enable the device 500 to provide output, such as via a display, a speaker, and/or a light-emitting diode. The communication component 560 may enable the device 500 to communicate with other devices via a wired connection and/or a wireless connection. For example, the communication component 560 may include a receiver, a transmitter, a transceiver, a modem, a network interface card, and/or an antenna.

The device 500 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

### INDUSTRIAL APPLICABILITY

The wireless communication device described herein may be used to control support functions of any machine that utilizes support functions, such as a paving machine, a milling machine, or another type of machine. In general, a challenge for controlling support functions of such a machine is that an operator in charge of the support functions is deployed on the ground at a work site to monitor a result of a work operation performed by the machine, and can control the support functions only by approaching and interacting with a control panel of the machine, while the machine is traveling. Due to constantly changing environmental conditions at the work site—such as weather, topography, and other factors—the operator is often not near the control panel and cannot control the support functions, even when needed. This can impact the machine's performance of a work operation and thus reduces a quality of the result of the work operation performed by the machine.

The wireless communication device described herein can pair (e.g. wirelessly pair) with a machine when the wireless communication device is near the machine, and therefore can cause a layout configuration to be applied to one or more input components of the wireless communication device for controlling support functions of the machine. In this way, the wireless communication device provides a support function control functionality that is not otherwise wirelessly available. Further, an operator in charge of the support functions of the machine can use the wireless communication device to control the support functions without needing to approach and interact with a control panel of the machine while the machine is traveling. This increases a likelihood that the operator is able to control the support functions of the machine when needed, regardless of environmental conditions of a work site, and regardless of the operator's position relative to the control panel of the machine. This improves the machine's performance of a work operation and thus increases a quality of the result of the work operation performed by the machine.

The wireless communication device can also support multiple layout configurations. For example, multiple layout configurations can be respectively associated with multiple modes of the machine (e.g., a work mode, a diagnostic mode, or a maintenance mode, along with other examples), and therefore the wireless communication device can cause a layout configuration to be applied to correspond to a mode in which the machine is operating. As another example, multiple layout configurations can be respectively associated with positions of the wireless communication device with respect to the machine (e.g., whether the device is in a position associated with a front side, a right side, a left side, a rear side, a top side, or a bottom side, along with other examples, of the machine), and therefore the wireless communication device can cause a layout configuration to be applied to correspond to a position of the wireless communication device (e.g., to enable the wireless communication device to control support functions of a particular side when the wireless communication device is in a position associated with the particular side of the machine). In this way, the wireless communication device provides an interoperable capability to allow for tailored control of the support functions of the machine.

The wireless communication device can also cause an output component of the wireless communication device to provide a presentation that indicates information associated with a position of the wireless communication device with respect to the machine, such as an alert or message that indicates that the wireless communication device is not within a preferred range of the machine. In this way, the wireless communication device can provide pertinent information to the operator of the wireless communication device, which can improve a control of the support functions of the machine.

The wireless communication device can also include a measurement component to obtain measurement information that is associated with a result of a work operation performed by the machine. This measurement information can then be used to facilitate control of at least one support function of the machine, and reduces a need for deploying other measurement devices at a work site (e.g., that would obtain similar measurement information).

The wireless communication device can be part of a system which allows for wireless communication between the wireless communication device and components of the machine. Additionally, one or more other wireless communication devices can be included in the system, which allows for multiple wireless communication devices to control support functions of the system. For example, a first wireless communication device may be utilized by an operator associated with a left side of the machine to control left side support functions of the machine, and a second wireless communication device may be utilized by an operator associated with a right side of the machine to control right side support functions of the machine. This type of functionality can facilitate tailored control of the support functions of the machine and adaptability for different types of work operations.

What is claimed is:

1. A wireless communication device, comprising:
a communication component configured to wirelessly communicate with a machine;
one or more input components; and
one or more processors configured to:
determine that the wireless communication device is paired to the machine;
identify, based on determining that the wireless communication device is paired to the machine, a first layout configuration associated with the machine,
wherein the first layout configuration identifies a correspondence between a particular input component, of the one or more input components, and a particular support function of the machine; and
cause the first layout configuration to be applied to the one or more input components.

2. The wireless communication device of claim 1, wherein the one or more processors, to determine that the wireless communication device is paired to the machine, are configured to:
obtain, from an input component, of the one or more input components, or the communication component, information that identifies the machine;
cause, based on obtaining the information that identifies the machine, the communication component to wirelessly transmit a wireless pairing request to the machine; and
obtain, wirelessly via the communication component, and after transmission of the wireless pairing request, a pairing confirmation from the machine.

3. The wireless communication device of claim 1, wherein the first layout configuration is associated with a first mode of the machine,
wherein the one or more processors are further configured to:
determine, after causing the first layout configuration to be applied to the one or more input components, that the machine transitioned from operating in the first mode to operating in a second mode;
identify a second layout configuration that is associated with the second mode of the machine,
wherein the second layout configuration identifies a correspondence between the particular input component and another particular support function of the machine; and
cause the second layout configuration to be applied to the one or more input components.

4. The wireless communication device of claim 1, wherein the one or more processors are further configured to:
obtain, wirelessly via the communication component, after causing the layout configuration to be applied to the one or more input components, information indicating a position of the wireless communication device with respect to the machine; and
cause, based on the information indicating the position of the wireless communication device with respect to the machine, at least one of:
a first set of one or more input components, of the one or more input components, to be enabled, or
a second set of one or more input components, of the one or more input components, to be disabled.

5. The wireless communication device of claim 1, further comprising:
an output component,
wherein the one or more processors are further configured to:
obtain, wirelessly via the communication component, after causing the layout configuration to be applied to the one or more input components, information associated with a position of the wireless communication device with respect to the machine; and
cause the output component to provide a presentation that indicates at least some of the information associated with the position of the wireless communication device with respect to the machine.

6. The wireless communication device of claim 1, further comprising:
a measurement component,
wherein the one or more processors are further configured to:
obtain, from the measurement component, measurement information associated with a result of a work operation performed by the machine; and
cause the communication component to wirelessly transmit the measurement information to the machine.

7. The wireless communication device of claim 1, wherein the communication component includes at least one of:
a radio frequency (RF) component,
a Bluetooth component,
a Zigbee component,
a WiFi component,
a Z-wave component,
a Matter component, or
a cellular component.

8. A system to facilitate wireless control of support functions of a machine, comprising:
a wireless communication device configured to:
determine that the wireless communication device is paired to a machine;
identify, based on determining that the wireless communication device is paired to the machine, a first layout configuration associated with the machine,
wherein the first layout configuration identifies a correspondence between a particular input component, of one or more input components of the wireless communication device, and a particular support function of the machine; and
cause the first layout configuration to be applied to the one or more input components of the wireless communication device.

9. The system of claim 8, further comprising a charging component configured to be included in the machine,
wherein the charging component is further configured to:
identify that a battery of the wireless communication device is in a charging position with respect to the charging component; and
cause, based on identifying that the battery of the wireless communication device is in the charging position, a battery charging operation to be initiated.

10. The system of claim 8, further comprising a communication component configured to be included in the machine,
wherein the communication component is further configured to wirelessly communicate with the wireless communication device to enable pairing of the wireless communication device to the machine.

11. The system of claim 8, further comprising a controller and communication component that are configured to be included in the machine,
wherein the communication component is further configured to wirelessly communicate with the wireless communication device;
wherein the controller is further configured to:
determine, after the wireless communication device causes the first layout configuration to be applied to the one or more input components, that the machine transitioned from operating in a first mode to operating in a second mode, and
cause, based on determining that the machine transitioned from operating in the first mode to operating in a second mode, the communication component to wirelessly transmit mode information associated with the machine to the wireless communication device; and
wherein the wireless communication device is further configured to:
identify, based on the mode information associated with the machine, a second layout configuration that is associated with the second mode of the machine,
wherein the second layout configuration identifies a correspondence between the particular input component and another particular support function of the machine; and
cause the second layout configuration to be applied to the one or more input components.

12. The system of claim 8, further comprising a controller and communication component that are configured to be included in the machine,
wherein the communication component is further configured to wirelessly communicate with the wireless communication device; and
wherein the controller is further configured to:
determine, based on information obtained from at least one of the communication component or one or more sensors of the machine, information indicating a position of the wireless communication device with respect to the machine, and
cause the communication component to wirelessly transmit the information indicating the position of the wireless communication device with respect to the machine to the wireless communication device.

13. The system of claim 12, wherein:
the wireless communication device is further configured to:
cause, based on the information indicating the position of the wireless communication device with respect to the machine, at least one of:
a first set of one or more input components, of the one or more input components, to be enabled, or
a second set of one or more input components, of the one or more input components, to be disabled.

14. The system of claim 12, wherein:
the wireless communication device is further configured to:
provide a presentation that indicates at least some of the information indicating the position of the wireless communication device with respect to the machine.

15. The system of claim 8, wherein:
the wireless communication device is further configured to:
obtain measurement information associated with a result of a work operation performed by the machine; and
wirelessly transmit the measurement information to the machine.

16. The system of claim 8, further comprising a controller that is configured to be included in the machine,
wherein the wireless communication device is further configured to:
identify, based on causing the first layout configuration to be applied to the one or more input components of the wireless communication device, that the particular input component is engaged, and
wirelessly transmit, based on identifying that the particular input component is engaged, control information associated with the particular support function to the machine; and
wherein the controller is further configured to:
obtain, wirelessly via a communication component of the machine, the control information associated with the particular support function, and
control one or more components of the machine in accordance with the control information associated with the particular support function.

17. The system of claim 8, further comprising another wireless communication device,
wherein the other wireless communication device is configured to cause a second layout configuration to be applied to one or more input components of the other wireless communication device,
wherein the first layout configuration is associated with a first side of the machine and the second layout configuration is associated with a second side of the machine that is different than the first side.

18. A method, comprising:
determining, by a wireless communication device, that the wireless communication device is paired to a machine;
identifying, by the wireless communication device, and based on determining that the wireless communication device is paired to the machine, a first layout configuration associated with the machine,
wherein the first layout configuration is associated with at least a particular support function of the machine; and
causing the first layout configuration to be applied to one or more input components of the wireless communication device.

19. The method of claim 18, further comprising:
identifying, after causing the first layout configuration to be applied to the one or more input components, a second layout configuration associated with the machine,
wherein the second layout configuration is associated with at least another particular support function of the machine; and
causing the second layout configuration to be applied to the one or more input components.

20. The method of claim 18, further comprising:
obtaining, after causing the first layout configuration to be applied to the one or more input components, information indicating a position of the wireless communication device with respect to the machine; and
selectively causing, based on the information indicating the position of the wireless communication device with respect to the machine, respective enablement or disablement of a set of one or more input components of the wireless communication device.
